(19) United States
(12) Patent Application Publication
(10) Pub. No.: US 2007/0156742 A1
(43) Pub. Date: Jul. 5, 2007

(54) Visual modeling method and apparatus

(76) Inventor: Jorge Gonzalez, Leon (ES)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,526

(22) Filed: Dec. 30, 2005

(51) Int. Cl. G06F 7/00; G06F 3/048

(52) U.S. Cl. 707/102; 715/764; 715/810

(57) ABSTRACT

In a computer system having a graphical user interface includes a display and a selection device, a method of providing and selecting from a menu on the display, the method including selecting a representation of a data set, selecting a representation of a business object from which the data set depends, and designating a specific business object to associate with the representation of the business object. The method also includes displaying as menu entries, a set of modeling information associated with a business object, selecting a subset of the set of modeling information associated with the business object, and associating the subset of the set of modeling information to the data set.

### BACKGROUND

In a business computing environment, reports are generated based on selected data. The data used is generally listed. The listing of data may also include information as to the origin of the data. The developer or designer of a report generally must know where the data is located. In some environments, data is controlled or managed by an object. In the event there are many objects, the developer or designer of the report must know which of the objects controls or manages what data. The necessary data is listed for the purpose of documenting the design of the report. Many times such a list is referred to as a flat list. When using a flat list, there is no high level view nor is there any structural information or even a context for the documented data. This makes developing or designing the report difficult. For example, a new developer or designer may know exactly what data is needed but is not familiar with all the objects that control data so it is difficult to get the data since it is controlled by one of a plurality of objects. Of course, this becomes more difficult as the number of objects that control data increase since data can be controlled by one of many objects.

Many times, outside consultants are called upon to develop or design reports for a company running another company's software. Outside consultants can also be called in to install reports. Since each company or business entity can customize objects, the data necessary to execute a report can be stored in different objects for different companies or business entities. Thus, the outside consultant must go on a fishing expedition to find the object that controls the information needed to generate a report. If an object is named in an unconventional way, the fishing expedition may take a longer time while the more conventional named objects are first explored to see if they control the necessary data.

Trouble shooting reports that act on data listed in a flat list may also take a long time. The trouble shooters have no high level view or context in which to check the data to make sure it is the appropriate data needed to generate a particular report. Generally, it may be difficult to debug reports or to maintain reports that are documented using a flat listing, since the flat listing of data provides little information but the source of the data. Thus, confirming that the data is correct may be difficult and time consuming. Finding the correct data may also be difficult and time consuming. Furthermore, determining that data current used is not the appropriate data may be difficult and time consuming.

### BRIEF DESCRIPTION OF THE DRAWINGS

FIG. 1 is a block diagram of a computing environment, according to an example embodiment.

FIG. 2 is a display of a model of a business object, according to an example embodiment.

FIG. 3 is a flow chart of a method of mapping data to a model of a business object, according to an example embodiment.

FIGS. 4A and 4B are a flow chart of another method of mapping data to a model of a business object, according to an example embodiment.

FIG. 5 is a display of a model of a business object and the data sources mapped to the business object, according to an example embodiment.

FIG. 6 is a block diagram showing the interrelationship between a business intelligence layer, an application program layer and a user interface, according to an example embodiment.

FIG. 7 is a block diagram of a system, according to an example embodiment.

FIG. 8 is a display of a visual designer, according to an example embodiment.

FIG. 9 is a display of a visual designer after designating a flow diagram from a business object to a report, according to an example embodiment.

FIG. 10 is a display of a visual designer including a menu for selecting the information used as a data source from a business object, according to an example embodiment.

FIG. 11 is a block diagram of a computer system that executes programming, according to an example embodiment.

FIGS. 12A and 12B are a flow chart of a method of mapping data to a model of a business object, according to an example embodiment.

FIG. 13 is a flow chart of another method of mapping data to a model of a business object, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

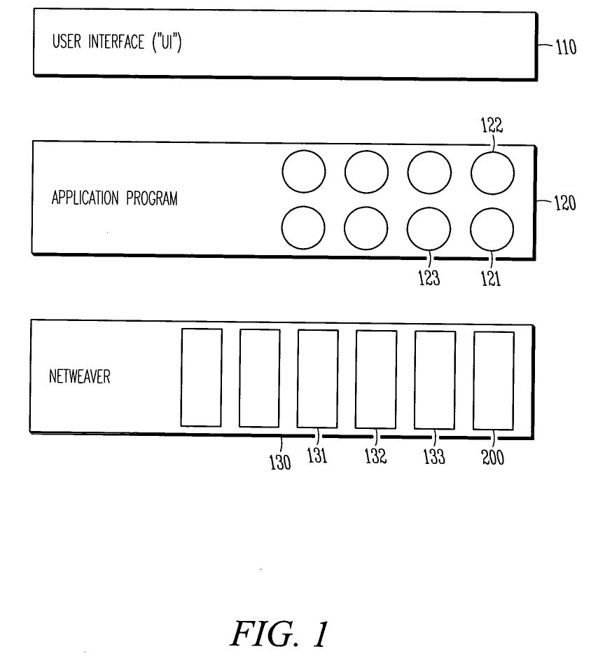

FIG. 1 is a block diagram of a computing system 100, according to an example embodiment. The computing environment 100 includes a user interface 110, an application program level 120 and a comprehensive integration and application platform layer 130. The comprehensive integration and application platform layer works with an existing infrastructure to enable and manage change. The comprehensive integration and application platform 130 includes a plurality of business applications, known as business components, which reduce the need for custom integration. The comprehensive integration and application platform includes a business component 131, 132, and 133. The comprehensive integration and application platform 130 also includes a business component 200, which includes various integration tools for performing business analysis on business information within the computing environment 100. The application program layer 120 also includes a number of distributed objects 121, 122, 123. The object is a technical representation of a concept that includes data and logic. In one example embodiment, the object, such as object 131, 132, 133 is referred to as a business object and is a technical representation of a business concept that includes data and logic.

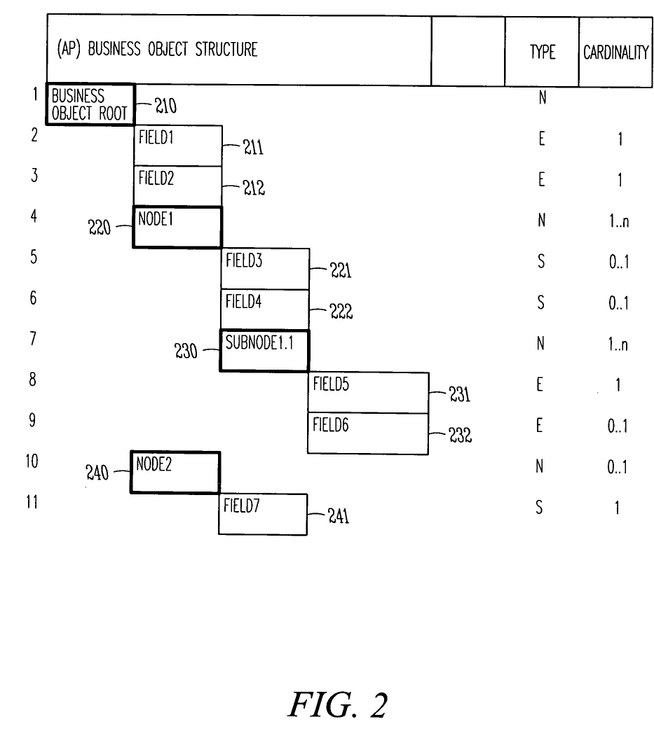

FIG. 2 is a display of a model 200 of a business object, such as business object 121, according to an example embodiment. A business object or object has a structure that includes a root 210, nodes such as nodes 220 and 240, and a sub node 230. Associated with a business or a root 210 is a grouping of information related to the business object root or root 210. Some of the information is held in fields such as 211 and 212. The information is also held in a node 220 which in turn also represents a grouping of information such as data and logic which are held in fields 221 and 222. Also under the root 210 and node 220 is a sub node 230. Sub node 230 holds another grouping of information that includes data and logic that are held in fields 231, 232. The business object 200 also includes another node 240. Node 240 is at the same level as node 220 and includes another grouping of data and logic which includes field 241. Therefore, it is seen that object 200 or business object 200 has a structure which includes a root 210, nodes, such as nodes 230 and 240, and sub nodes, such as sub node 230. It should be noted that FIG. 2 shows a simplified example of the structure of an object or business object 200. In actuality, a business object or object 200 may have a more complex structure. However, the principles as set forth in FIG. 2 will be followed where each root, node and/or sub node includes a grouping of information that can include data and logic.

In some embodiments, the structure of the business object or an outline of the business object is used to form a model of the business object 200. A model is useful for the purposes of designing and programming in a business object, such as business object 200. A model of the business object 200 shows the structure. In some embodiments, the model is referred to as a template. A template or model can take on any form just so it shows the structure of the object or business object 200. As shown in FIG. 2, the template is formed on a spreadsheet, such as an Excel spreadsheet. Excel is a registered trademark of Microsoft Corporation.

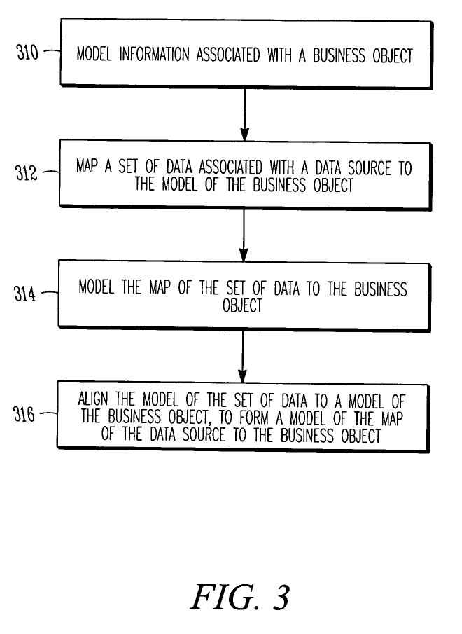

FIG. 3 is a flowchart of a method 300 of mapping data to a model of a business object 200, according to an example embodiment. The method 300 includes modeling information associated with a business object 310, and mapping a set of data associated with a data source to the model of the business object 312. The method 300 can also include modeling the set of data associated with the data source 314, and aligning the model of the set of data to a model of the business object, to form a model of the map of the data source to the business object 316. In one example embodiment, the model of the business object is a template, and in still another embodiment, the model of the business object is template is in the form of a spread sheet.

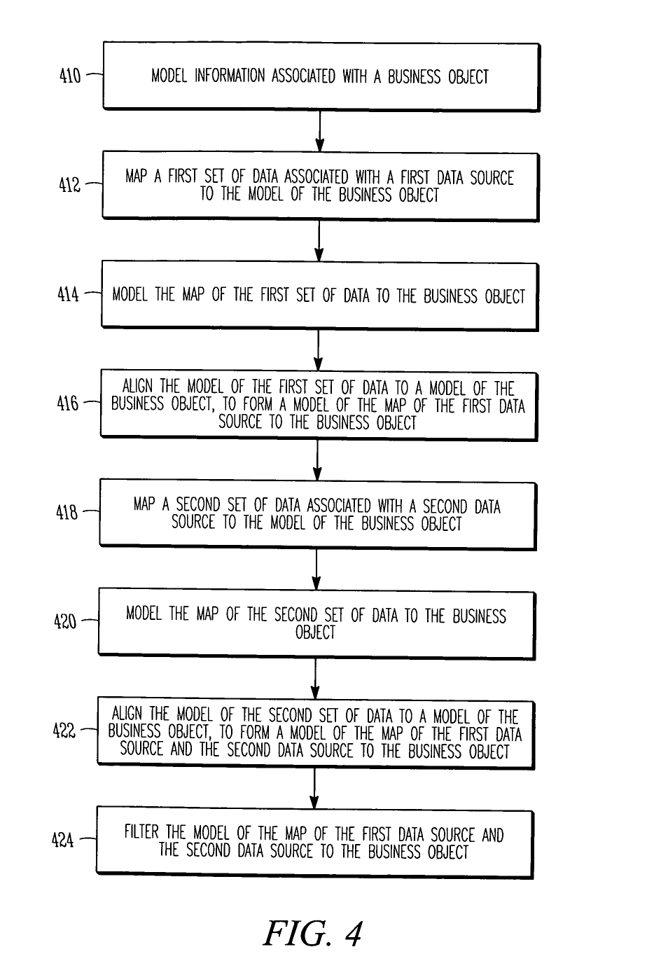

FIGS. 4A and 4B are a flow chart of another method 400 of mapping data to a model of a business object, such as the model 200, according to an example embodiment. The method includes modeling information associated with a business object 410 and mapping a first set of data associated with the first data source to the model of the business object 412. The method 400 includes modeling the map of the first set of data to the business object 414 and aligning the model of the first set of data to the model of the business object to form a model of the map of the first data source to the business object 416. The method also includes mapping a second set of data associated with a second data source to the model of the business object 418 and modeling the map of the second set of data to the business object 420. The model of the second set of data is then aligned to the model of the business object to form a model of the map of the first data source and the second data source to the business object, as depicted by reference numeral 422. In some embodiments of the invention, a filter is provided to allow filtering of the model of the map of the first data source and the second data source to the business object 424. Filtering includes determining the data or information associated with the first data source as it relates to a business object and determining only the data of the second data source as it relates to a business object. In some embodiments of the invention, models of several business objects and related data sources can be placed together, or the model may include more than one business object. In such an example embodiment, filtering may also be done to determine which of the business objects are associated with one or more data sets.

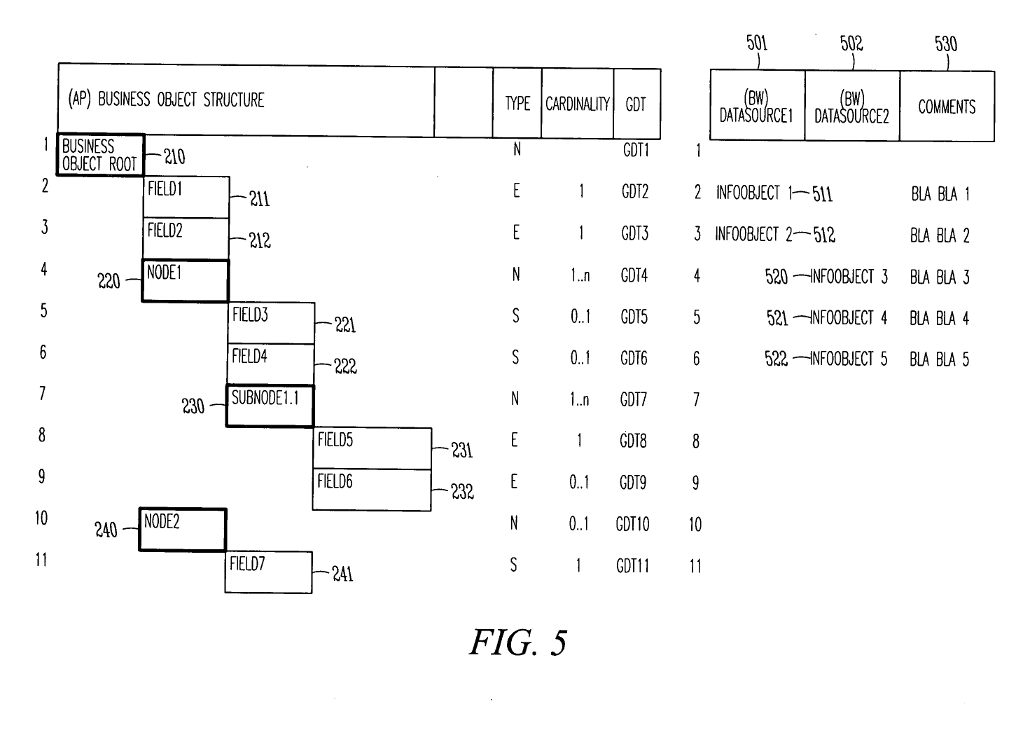

FIG. 5 is a display of a model 500 of a business object, a first data source and a second data source as they are mapped to the business object, according to an example embodiment. The model 500 includes the structure of the business object which is substantially the same as shown in FIG. 2. In other words, the structure of the model includes the structure of the business object or object with a root 210, a node 220, and a node 240, and a sub node 230 beneath the node 220. Below the business object are fields 211 and 212 and associated or related to node 1 are fields 221 and 222. Also related to sub node 230 are fields 231 and 232. And also associated with node 240 is field 241. Each of the nodes, sub nodes or roots represents an association or collection of information that includes data and logic.

The business object or object also includes data or is a controller of data that is placed in a data source. The data source 1 and all of the pieces of data associated therewith are shown in column 501 of the model of the business object and data sources 500. Similarly, the data associated with the data source 2 is shown in column 502 of the model of the business object and data sources 500. Each of the individual portions of data in a data source is referred to as an info object. Data source 1 includes info objects 511 and 512. The model 500 is both a mapping of the info objects 511 and 512 to the data source as well as a model which shows the data source for a developer of various reports or objects that rely upon a data source to perform an operation. For example, the info object 511 is on line 2 and therefore corresponds to the data found in field 1 or field 211 underneath the root 210 of the business object. Similarly, info object 512 corresponds to the information or data found in field 2 or field 212 of the object or business object. The model 500 also includes a mapping as well as a modeling of the info objects 520, 521, 522 associated with the second data source 502. Info object 3 corresponds to the information or data found at node 220, info object 521 corresponds to the information or data found in field 221 of the business object, and info object 522 corresponds to the information or data found in the field 222 of the business object or object. Each of the info objects can be provided with a new name to describe the info object. In some example embodiments, the respective info object keeps or maintains the name of the field or node or sub node or root from which it depends. The model 500 also includes a comment field 530. The columns of the various data sources 501, 502 that have respective info objects therein associated with a data source 1 and data source 2 can be used as a filter. In other words, the column 501 can be viewed in the info objects shown that correspond to data and information and mapped to the structure of the object. In addition, the business object or the model can be sorted such that column 2 shows the related structure associated with the business object.

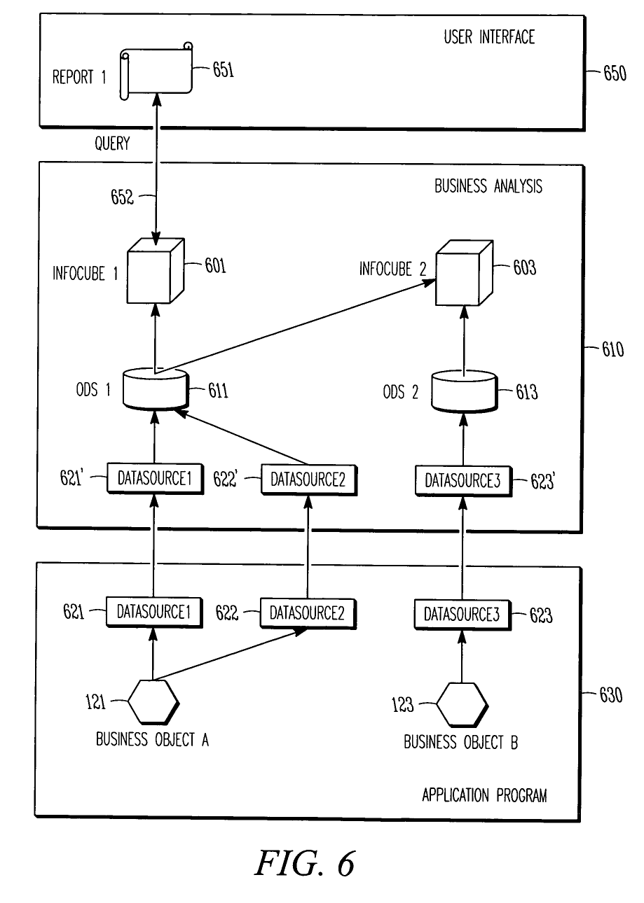

FIG. 6 is a block diagram 600 showing the interrelationship between a business analysis layer 610, an application program layer 630 and a user interface 650. The business analysis layer 610 is used to provide analysis on data from business objects or objects such as objects 121 and 122 found in the application program layer 630. The end result of business analysis is that a report 651 is produced at the user interface 650. The user can either print the report 651 or view it online via the user interface 650. The report 651 requires certain data to be analyzed by the business analysis layer 610. The source of the data or information that is analyzed is the business objects 121, 123 found in the application program layer 630. As mentioned previously, the business object or object 121 is a grouping of information that includes data and logic that is related to a concept. A data source, such as data source 621, 622 or 623 is a subset of the information associated with a particular business object or object. For example, data source 621 and data source 622 each include a subset of the information found in business object 121. In addition, data source 623 includes a subset of the information found in business object 123. The data sources are defined by what is necessary to produce a report 651. The data sources are initially produced in the application program layer or portion 630.

Once produced, a mirror of each data source 621′, 622′, and 623′ is formed in the business analysis layer 610. The data sources 621′, 622′, 623′ are checked for data integrity and placed into a storage area depicted by info cube 601 and infocube 603 in the business analysis layer. The data is checked for integrity or scrubbed or cleansed as depicted by the operational data store 611 or an operational data store 613, before placing the data into an infocube 601 or 603. For example, the data associated with data source 621′ and 622′ is placed into an operational store 611 and then into an infocube 601. The operational data store 611 and the infocube 601 represent cleansing or scrubbing or checking the data for integrity and placing it into an information area or data storage area where it can be queried to produce a report. The query is depicted by the connector carrying the reference numeral 652. Provided that the query or the set of queries necessary to form the report are correct, and the data in the infocube or data storage area 601 is correct, a proper or current report 651 is produced at the user interface.

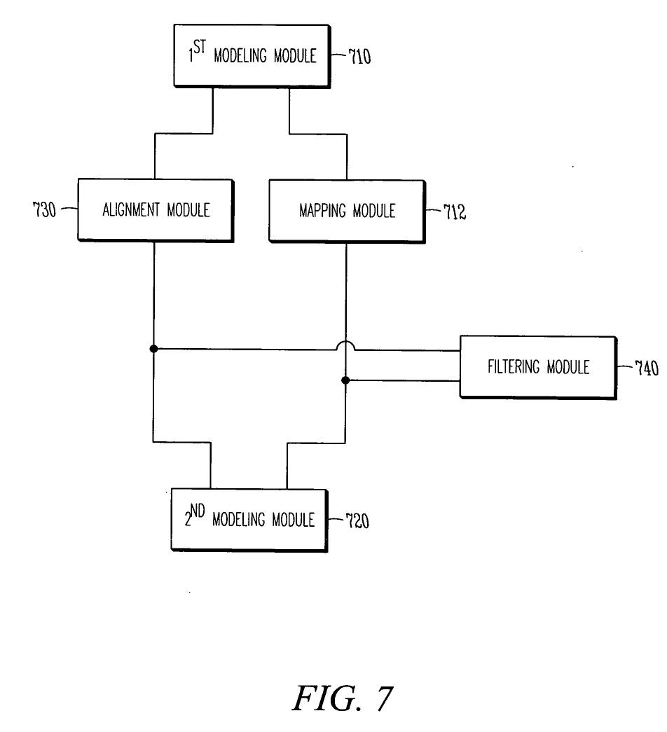

FIG. 7 is a block diagram of a system 700, according to an example embodiment. The system 700 includes a modeling module 710 that models information associated with a business object, and a mapping module 712 that maps a set of data associated with a data source to the model of the business object. The system 700 may also include a second modeling module 720 that models the set of data associated with the data source, and an alignment module 730 that aligns the model of the set of data to a model of the business object, to form a model of the map of the data source to the business object. The system 700 can also include a filtering module 740 that filters information associated with the model of the data source and the model of the business object. The system 700 and the various modules 710, 712, 720, 730, 740 can be implemented in either hardware or software or a combination of the two. The various modules can be implemented as parts of a computer system. The system can also be provided with a user interface that is helpful in designing a producing reports.

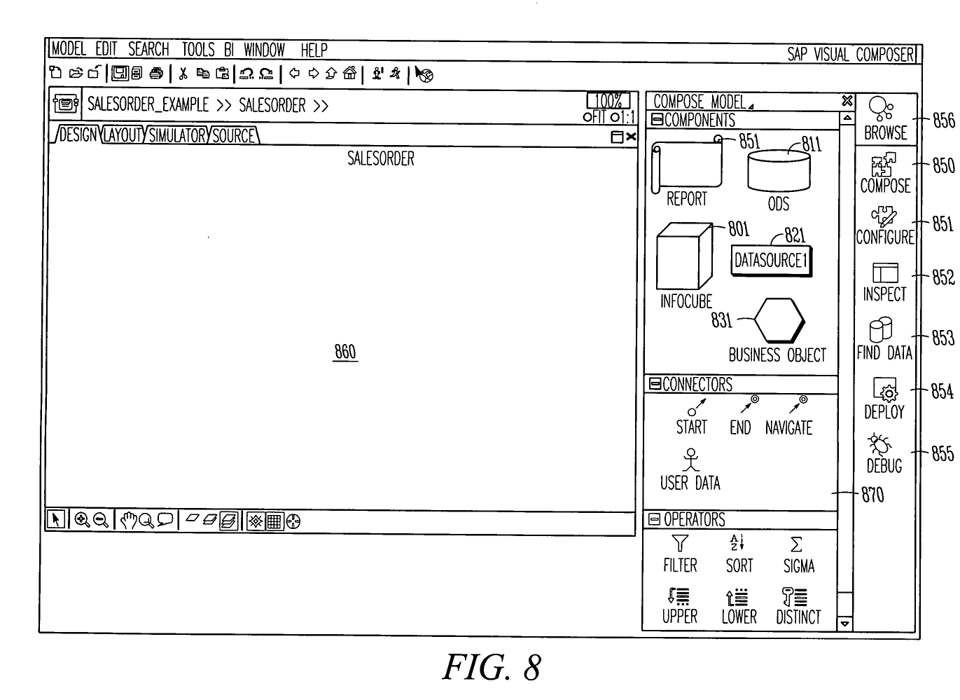

FIG. 8 is a display of a visual designer 800, according to an example embodiment. FIG. 8 is a screen shot of the visual designer 800. The screen includes various components, such as a report component 851, and ODS component 811, an infocube component 801, a data source component 821, and a business object component 831. These components are representations of the various reports, ODS's, infocubes, data sources and business objects that could be associated with a report in the process of obtaining data, producing a data source, cleansing or scrubbing the data and placing it into a data area that can be queried to produce a report. As shown in the screen shot of FIG. 8, the visual designer 800 also has several modes including a composed mode 850, a configure mode 851, an inspect mode 852, a find data mode 853, a deploy mode 854, a debug mode 855, and a browse mode 856. As shown in FIG. 8, the visual designer 800 is in a composed mode. When in the composed mode, the various components can be dragged and dropped on to the main screen or a main design screen 860. The various components can then be connected using connectors, which are collectively shown or displayed at the area 870 on the screen shot shown in FIG. 8.

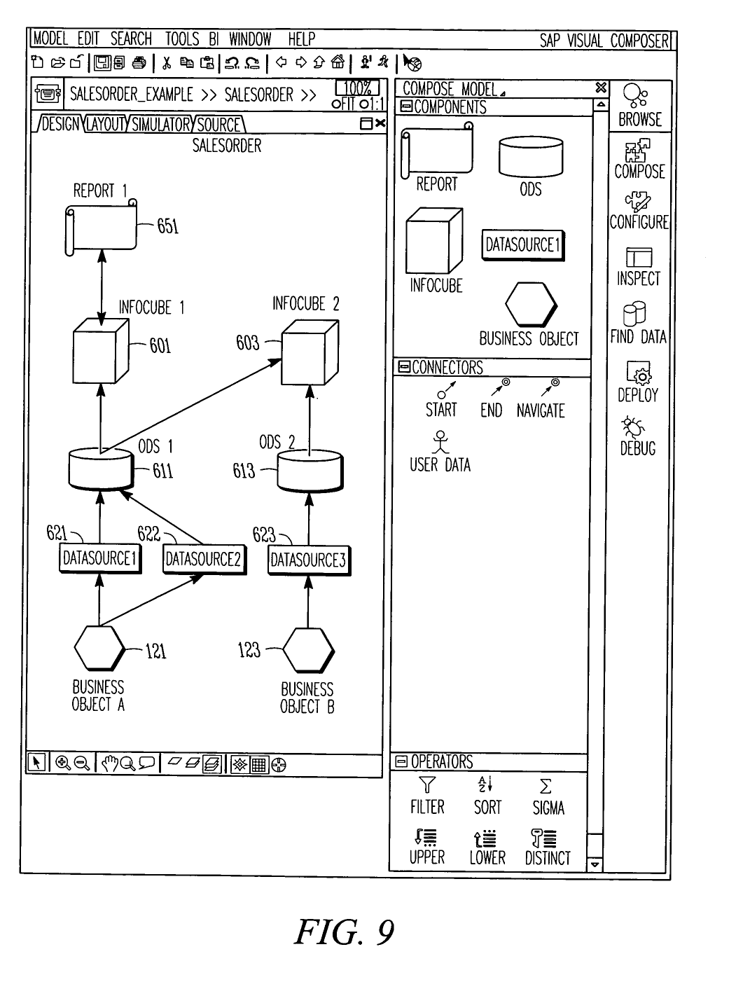

FIG. 9 is a screen shot 900 of the visual designer after designating a flow diagram from a business object to a report, according to an example embodiment. The flow diagram shown in the screen shot 900 includes the same elements as shown in the interrelationship between the application program layer, the business analysis layer and the user interface layer shown in FIG. 6. The difference between the flow diagram shown in the screen shot 900 of FIG. 9 and the interrelationship shown in FIG. 6 is that the screen shot does not include the various layers including the application program layer 630, the business analysis layer 610, and the user interface layer 650. These are eliminated thereby simplifying the view of the flow diagram.

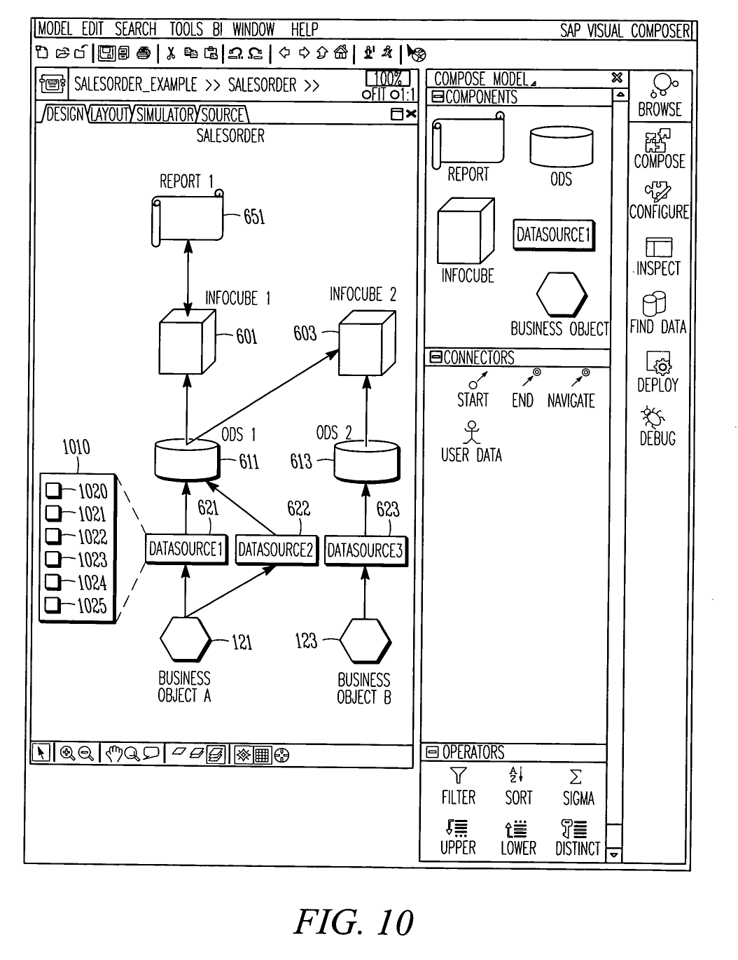

FIG. 10 is a screen shot 1000 of the visual designer while the data source or data source 621 is being designated or selected, according to an example embodiment. To populate or determine what data will be within a data source 621, the data source is selected and a pull-down menu that includes the structure of the business object 121 is placed in a pop-up menu 1010. The pop-up menu includes boxes that can be used to select the various info objects or the various fields, nodes, or sub nodes associated with the business object 121. The pop-up menu 1010 includes selection boxes 1020, 1021, 1022, 1023, 1024, and 1025. In order to designate what information from the business object will be used to populate the data source 621 the designer merely checks off the various boxes to select a particular field, node, root, or sub node associated with the object or business object. An example of the structure is shown in FIG. 2 of the application. Once the boxes are selected, the design can be saved. A report can also be similarly displayed by clicking on the representation of the report 651. The design can then be saved in the visual design mode and circulated amongst the designers. Once the basic design is agreed upon, the design can be implemented by selecting the deploy mode 854. The deploy mode populates the data sources 621, 622 and 623 produces the mirror of the data sources 621′, 622′, 623′ (shown in FIG. 6) implements cleansing or scrubbing or checking the data for integrity and placing the data in the infocubes 601 and 603 and automatically queries the infocubes 601 to produce the report 651.

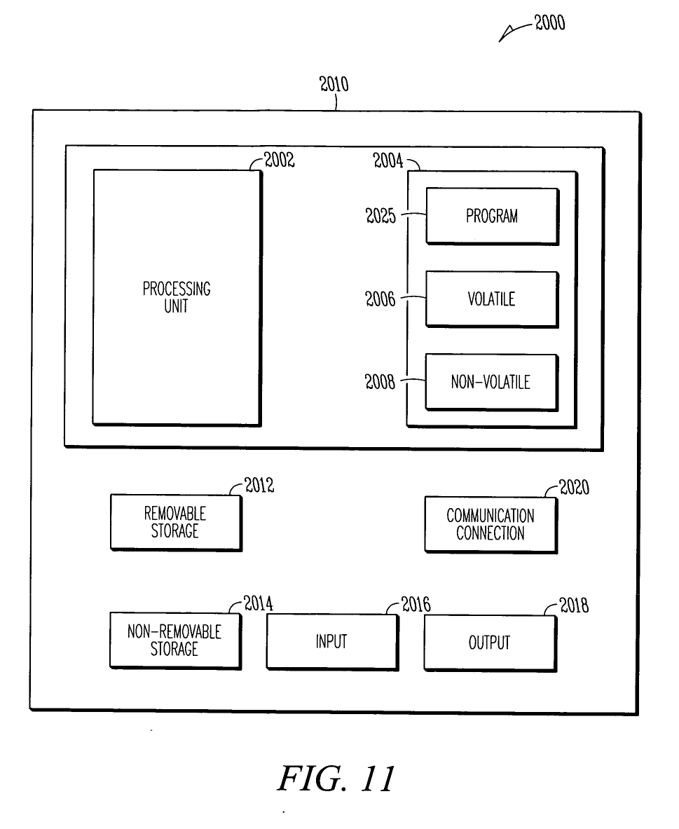

A block diagram of a computer system that executes programming for performing the above algorithm is shown in FIG. 11. A general computing device in the form of a computer 2010, may include a processing unit 2002, memory 2004, removable storage 2012, and non-removable storage 2014. Memory 2004 may include volatile memory 2006 and non-volatile memory 2008. Computer 2010 may include, or have access to a computing environment that includes, a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. One of the inputs could be a keyboard, a mouse, or other selection device. The communication connection 2020 can also include a graphical user interface, such as a display that would show the screen shots including the representative icons of FIGS. 8-10. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2002 of the computer 2010. A hard drive, CD-ROM, and RAM are some examples of articles including a computer-readable medium. For example, a computer program 2025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 2000 to provide generic access controls in a COM based computer network system having multiple users and servers.

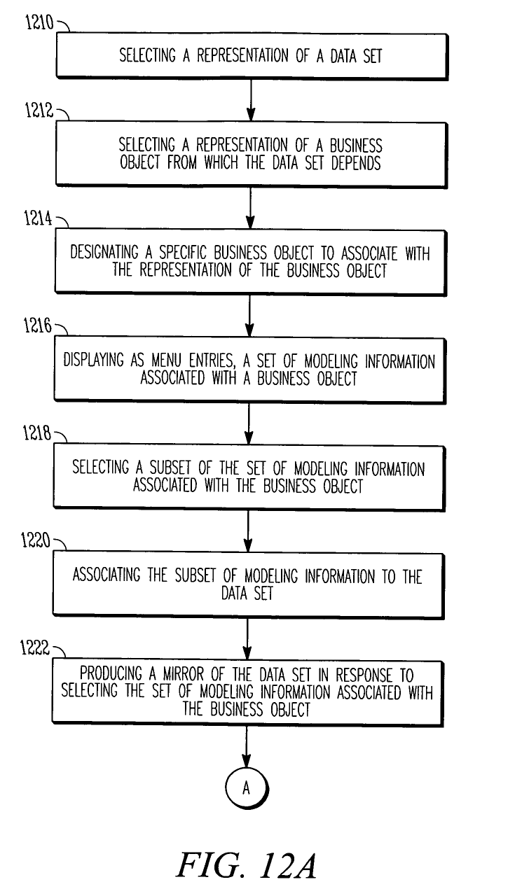

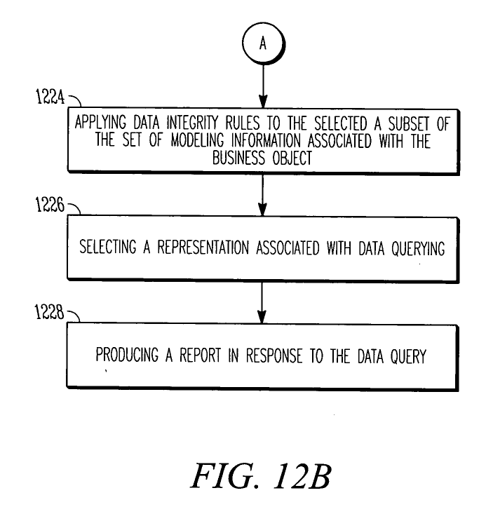

FIGS. 12A and 12B are a flow chart of a method of mapping data to a model of a business object, according to an example embodiment. In a computer system, such as the computing system 2010, having a graphical user interface, a display and a selection device, the method 1200 includes providing and selecting from a menu on the display, and includes selecting a representation of a data set 1210, selecting a representation of a business object from which the data set depends 1212, and designating a specific business object to associate with the representation of the business object 1214. The method 1200 also includes displaying as menu entries, a set of modeling information associated with a business object 1216, selecting a subset of the set of modeling information associated with the business object 1218, and associating the subset of the set of modeling information to the data set 1220. In some embodiments, associating the subset of modeling information to the data set 1220 includes mapping the subset of data associated with the data source to a model of the business object. In other embodiments, associating the subset of modeling information to the data set 1220 includes mapping the subset of data associated with the data source to a model of the business object and producing a model that includes the business object modeling information and the subset of data associated with the data source. The method 1200 can also include producing a mirror of the data set in response to selecting the set of modeling information associated with the business object 1222. In some embodiments, producing a mirror of the data 1222 includes replicating the data for analysis by a business analysis portion of the computer system. Designating a business object from which the data set depends 1212 includes selecting a representation of a connector, and attaching the representation of a connector between a representation of a business object and a representation of a data set. The method 1200 can also include selecting a representation associated with applying data integrity rules to the selected a subset of the set of modeling information associated with the business object 1224. The method 1200 also can include selecting a representation associated with querying data 1226. The method 1200 may further include selecting a representation associated with data querying 1226, and producing a report in response to the data query 1228. In some embodiments, the data query may have to be designated.

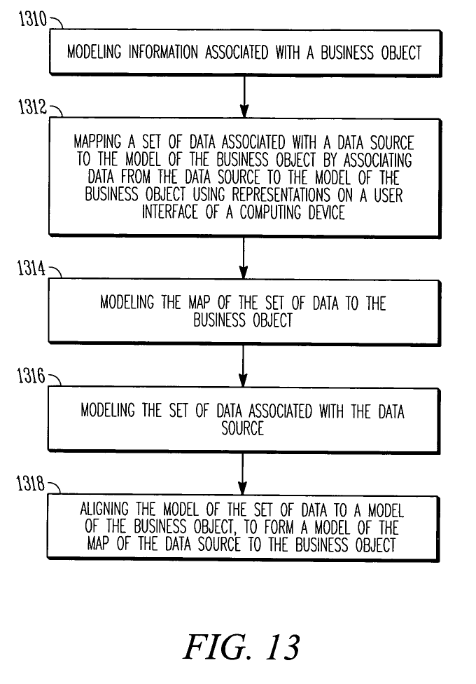

FIG. 13 is a flow chart of another method of mapping data to a model of a business object, according to an example embodiment. The method 1300 includes modeling information associated with a business object 1310, and mapping a set of data associated with a data source to the model of the business object by associating data from the data source to the model of the business object using representations on a user interface of a computing device 1312. The method 1300 further includes modeling the map of the set of data to the business object 1314. The method 1300, in some embodiments, also includes modeling the set of data associated with the data source 1316, and aligning the model of the set of data to a model of the business object, to form a model of the map of the data source to the business object 1318. The method wherein the model of the map of the set of data associated with a data source to the model of the business object is queried to produce a report.

In one example embodiment, the visual designer 800 produces the model 500 of a business object, a first data source and a second data source as they are mapped to the business object as complementary information to the visual designer. The visual designer 800 provides the designer of a report with a more intuitive design tool. The visual designer 800 also provides for an method to review data sources and correct them through a user interface. This may be useful for redesigning a report or troubleshooting a report for missing or incorrect information. Adding the use of the model 500 that includes the map of the various data sources to the business objects can be of further use in some situations. In short, there is a value to the designer and to those that interact with the design of being able to interact with the whole dataflow from the business object to the report through the user interface.

A machine-readable medium that provides instructions that, when executed by a machine, cause the machine to perform operations including representing a data set with a data set icon, representing a selected business object from which the data set depends with a business object icon, and displaying as menu entries, a set of modeling information associated with a business object. The machine-readable medium also includes instructions for selecting a subset of the modeling information from the menu entries, and associating the subset of the set of modeling information to the data set using the data set icon, the business object icon and a selected subset of modeling information The machine-readable medium also includes that, when executed by a machine, cause the machine to perform the operation of associating the subset of modeling information to the data set that includes mapping the subset of data associated with the data source to a model of the business object. The machine-readable medium of also includes instructions that cause the machine to perform the operation of associating the subset of modeling information to the data set by mapping the subset of data associated with the data source to a model of the business object and producing a model that includes the business object modeling information and the subset of data associated with the data source. In some embodiments, the machine-readable medium provides instructions that, when executed by a machine, further cause the machine to perform operations including producing a mirror of the data set in response to selecting the set of modeling information associated with the business object. In some embodiments, producing a mirror of the data includes replicating the data for analysis by a business analysis portion of the computer system. In still other embodiments, designating a business object from which the data set depends includes selecting a representation of a connector, and attaching the representation of a connector between a representation of a business object and a representation of a data set.

A machine-readable medium provides instructions that, when executed by a machine, causes the machine to perform operations including modeling information associated with a business object, and mapping a set of data associated with a data source to the model of the business object. The machine-readable medium can further cause the machine to perform operations including modeling the map of the set of data to the business object. The machine-readable medium can further cause the machine to model the set of data associated with the data source, and align the model of the set of data to a model of the business object to form a model of the map of the data source to the business object. In some example embodiments, the machine-readable medium also causes the machine to map a set of data associated with a second data source to the model of the business object. The machine-readable medium can further cause the machine to filter the data associated with the second data source and the first data source.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. In a computer system having a graphical user interface including a display and a selection device, a method of providing and selecting from a menu on the display, the method comprising:
selecting a representation of a data set;
selecting a representation of a business object from which the data set depends;
designating a specific business object to associate with the representation of the business object;
displaying as menu entries, a set of modeling information associated with a business object;
selecting a subset of the set of modeling information associated with the business object; and
associating the subset of the set of modeling information to the data set.

2. In the computer system having a graphical user interface of claim 1, wherein associating the subset of modeling information to the data set includes mapping the subset of data associated with the data source to a model of the business object.

3. In the computer system having a graphical user interface of claim 1, wherein associating the subset of modeling information to the data set includes mapping the subset of data associated with the data source to a model of the business object and producing a model that includes the business object modeling information and the subset of data associated with the data source.

4. In the computer system having a graphical user interface of claim 1 further comprising producing a mirror of the data set in response to selecting the set of modeling information associated with the business object.

5. In the computer system having a graphical user interface of claim 4 wherein producing a mirror of the data includes replicating the data for analysis by a business analysis portion of the computer system.

6. In the computer system having a graphical user interface of claim 1 wherein designating a business object from which the data set depends includes:
selecting a representation of a connector; and
attaching the representation of a connector between a representation of a business object and a representation of a data set.

7. In the computer system having a graphical user interface of claim 1 further comprising selecting a representation associated with applying data integrity rules to the selected a subset of the set of modeling information associated with the business object.

8. In the computer system having a graphical user interface of claim 7 further comprising selecting a representation associated with querying data.

9. In the computer system having a graphical user interface of claim 8 further comprising:
selecting a representation associated with data querying; and
producing a report in response to the data query.

10. In the computer system having a graphical user interface of claim 9 further comprising designating the data query.

11. A machine-readable medium that provides instructions that, when executed by a machine, cause the machine to perform operations comprising:
representing a data set with a data set icon;
representing a selected business object from which the data set depends with a business object icon;
displaying as menu entries, a set of modeling information associated with a business object;
selecting a subset of the modeling information from the menu entries; and
associating the subset of the set of modeling information to the data set using the data set icon, the business object icon and a selected subset of modeling information.

12. The machine-readable medium of claim 11 that provides instructions that, when executed by a machine, cause the machine to perform operations, wherein associating the subset of modeling information to the data set includes mapping the subset of data associated with the data source to a model of the business object.

13. The machine-readable medium of claim 11 that provides instructions that, when executed by a machine, cause the machine to perform operations, wherein associating the subset of modeling information to the data set includes mapping the subset of data associated with the data source to a model of the business object and producing a model that includes the business object modeling information and the subset of data associated with the data source.

14. The machine-readable medium of claim 11 that provides instructions that, when executed by a machine, further cause the machine to perform operations including producing a mirror of the data set in response to selecting the set of modeling information associated with the business object.

15. The machine-readable medium of claim 14 that provides instructions that, when executed by a machine, cause the machine to perform operations, wherein producing a mirror of the data includes replicating the data for analysis by a business analysis portion of the computer system.

16. The machine-readable medium of claim 11 that provides instructions that, when executed by a machine, cause the machine to perform operations, wherein designating a business object from which the data set depends includes:
selecting a representation of a connector; and
attaching the representation of a connector between a representation of a business object and a representation of a data set.

17. A method comprising:
modeling information associated with a business object; and
mapping a set of data associated with a data source to the model of the business object by associating data from the data source to the model of the business object using representations on a user interface of a computing device.

18. The method of claim 17 further comprising modeling the map of the set of data to the business object.

19. The method of claim 17 further comprising:
modeling the set of data associated with the data source; and
aligning the model of the set of data to a model of the business object, to form a model of the map of the data source to the business object.

20. The method of claim 17 wherein the model of the map of the set of data associated with a data source to the model of the business object is queried to produce a report.
